(19) United States
(12) Patent Application Publication
(10) Pub. No.: US 2002/0123377 A1
(43) Pub. Date: Sep. 5, 2002

(54) Computer assisted poker tournament

(76) Inventor: Barry Shulman, Las Vegas, NV (US)

Correspondence Address: Quirk & Tratos, Suite 500 North, 3773 Howard Hughes Parkway, Las Vegas, NV, 89109, US

(21) Appl. No.: 09/797,767

(22) Filed: Mar. 1, 2001

(51) Int. Cl. A63F 13/00; G06F 17/00

(52) U.S. Cl. 463/13; 463/42

(57) ABSTRACT

A computer assisted poker tournament is conformed for computer network display where observers can view various virtual poker tables and decide if they want to participate at this table. Upon deciding to participate the observer pays an entry fee, is given a corresponding number of virtual playing chips and then can bet these chips over the network. Now as a participant the network player can elect to withdraw from the tournament for any desired period of time and may re-enter any virtual tournament table that has openings in it. At a specified time the participant's total winnings are compared against those of other players to determine the tournament winner.

### BACKGROUND OF THE INVENTION

1. Field of the Invention

The present invention relates to gaming systems carried out on a computer network, and more particularly to a poker tournament carried out on a network in which the contestants can enter and leave at will while maintaining participation in the tournament.

2. Description of the Prior Art

Poker tournaments have been known in the past. Typically the participants in the tournament each pay an entry fee which allows them to sit at one of several poker tables where they compete against each other to see which one will be left with the winnings. The winners from each table then progress upwardly to the next set of tables, where they again compete against each other and so on. Of course, progressive limits need to be imposed at each level of play and in typical practice it is the betting limit that is increased with each advancement to the next level. Those that survive this heightened betting intensity are then advanced to the next level with the winnings earned.

This conventional practice compels the contestants to remain engaged in the contest while the elimination process takes place. Even at a most minimal participation level an ante needs to be paid at the beginning of each hand and it is the progressive collection of the other players' chips that eventually determines the table winner. Thus the players' continued table presence and attention are required, compelling other participation in the form of bets or raises as are deemed likely to produce a winner.

In accordance with the current practice each contestant's ultimate objective is to be the survivor at each poker table, concluding at the final table contest. This eliminative nature of the tournament entails full dedication and focus on the part of only those that are still contestants. Thus the pool of those keenly interested in the tournament keeps shrinking until there is only those few that are sitting at the last table and it is this shrinking population aspect that has rendered a poker tournament less than attractive as an attention garnering mechanism in computer assisted networks.

In the past various techniques have been devised which in one way or another seek to garner the attention of those communicating with a computer network. Examples of such attention garnering techniques can be found in the teachings of U.S. Pat. No. 5,794,210 to Goldhaber et al; U.S. Pat. No. 6,061,660 to Eggleston et al; U.S. Pat. No. 6,039,244 to Finsterwald; and others. While suitable for the purposes intended each of the foregoing fails to take benefit of the inherent attention compelling attribute associated with poker and by virtue of the reducing nature of the participant ranks in each of these processes reduce rather than expanding the number of those compelled to maintain interest. Few techniques are therefore available for the promoter to resolve this constant paradox.

Heretofore a variety of gaming systems have been devised which in one way or another are accomplished on a computer communication network. Examples of such network gaming systems can be found in U.S. Pat. No. 6,007,426 to Kelly et al., U.S. Pat. 5,851,149 to Xidos et al., U.S. Pat. No. 5,762,552 to Vuong et al., and others. Each of these, again, includes the inherently shrinking population of contestants.

Techniques for attracting the largest number of participants to the most compelling end portions of a tournament are therefore extensively sought and it is one such technique that is described herein.

### SUMMARY OF THE INVENTION

Accordingly it is the general purpose and object of the present invention to provide a method for carrying out a computer network distributed poker tournament in which the tournament contestants may omit tournament participation at any given time prior to the tournament conclusion.

Other objects of the invention are to provide a method for effecting a network distributed poker tournament that is convenient for selective participation in the tournament.

Yet further objects of the invention are to provide a method for a network distributed poker tournament which allows the tournament participants the convenience of selecting the time periods during which the player will participate in a tournament.

These and other objects are accomplished within the present invention by way of a computer network to which a plurality of user terminals may be tied. Each of the terminals, in accordance with conventional practice, may be conformed as a personal computer or similar data processing device communicating at the will of the user with a central computing facility that acts as a tournament promoter or the house.

To ensure that unwanted interference and hacking are kept to a minimum, each of the remote terminals may be provided with an encryption interface and other techniques for securing the data exchange with the central processing facility. At the same time parts of the data may be concurrently carried on the network in unencrypted and unsecured format in order to facilitate public access and thereby attract observers. Thus, each of the remote terminals may function in one of two states, either as a tournament participant's terminal that requires encryption and other security features, or as a display terminal for a passive observer. In the latter mode the attention garnering aspects of a poker tournament may be utilized by other advertising information carriers, in the form of advertising banners and links to other sites.

In the instances of a poker tournament carried out in accordance with the present invention, the information displayed to those that are merely observers is essentially the same information as one would observe in a casino or other gaming establishment if one were permitted access to view the poker tournament. Thus the observer will be able select the table that he or she wishes to observe, to see all such cards as may have been dealt face up at that table and the number of those dealt face down, the bets made in the course of the current game, the number of chips or the remaining purse that each of the players still has at the table, and so on. Of course the observer would also see if there are any vacant seats at the table.

This network observer can then scan from one table to the other and in the course of this scan can ascertain the type of players that are engaged in the game, their betting habits, the aggressiveness of their play, and so on. In this manner the potential tournament candidate can examine the tournament caliber, the player table groupings, and thereby enable his or her decision to participate.

Once a decision is made to participate in the tournament the new entrant effects the entry fee payment by way of any generally known credit card or bank card debit and credit techniques. Having made such a payment the encryption code is then transferred or downloaded to the new tournament participant's data processing facility together with various identification codes and other security information. The new entrant is thus equipped to join any of one of the ongoing poker tables as vacancies occur. Alternatively, the new entrant may simply elect to wait until a vacancy occurs at the table of his or her choice. Once at the table, this new entrant can now elect to suspend his or her participation at any time, collecting his winnings or losses to become an observer again.

In accordance with the present invention the tournament winners are selected by the size of their respective winnings, referred to as purses herein, at a specified time in the future. Those in the art will appreciate that as this time approaches the contestants that are still in the tournament will turn to more aggressive play. Moreover the more proficient poker players that are still observing may elect to enter the contest, and it is their potential entry that motivates the other remaining contestants to advance to the more sophisticated levels of the game. Thus unlike the tournaments in the prior art this increasing intensity builds interest towards the end of the tournament rather than eliminating the level of participation.

### BRIEF DESCRIPTION OF THE DRAWINGS

FIG. 1 is a diagrammatic illustration of a computer network useful in carrying out the inventive poker tournament described herein;

FIG. 2 is yet another diagrammatic illustration of the various signal paths that may be carried out on the network shown in FIG. 1 to effect the inventive method of tournament poker;

FIG. 3 is a flowchart illustrating the sequence of steps carried out with the assistance of the computer systems tied to a network for engaging in the inventive poker tournament; and

FIG. 4 is a diagrammatic illustration of a video screen image layout in accordance with the present invention.

### DESCRIPTION OF THE PREFERRED EMBODIMENT

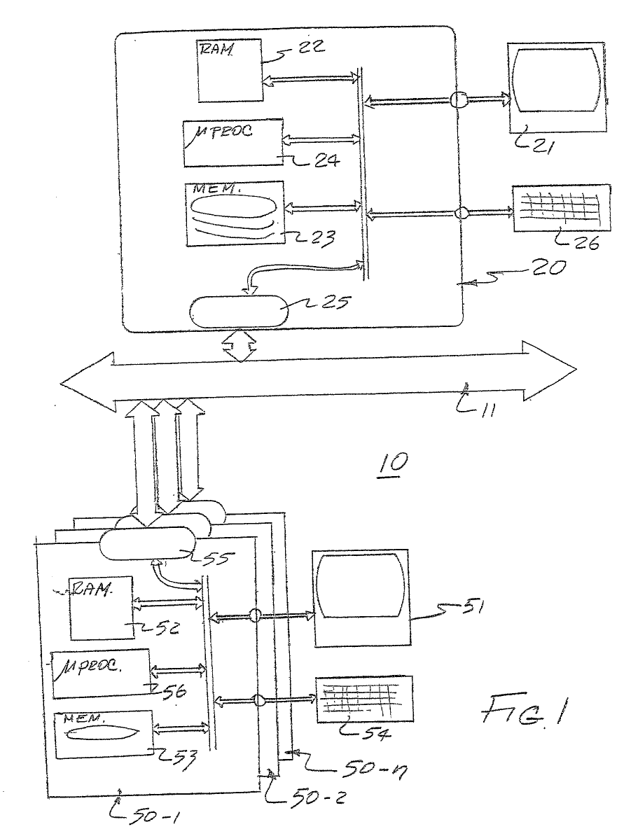

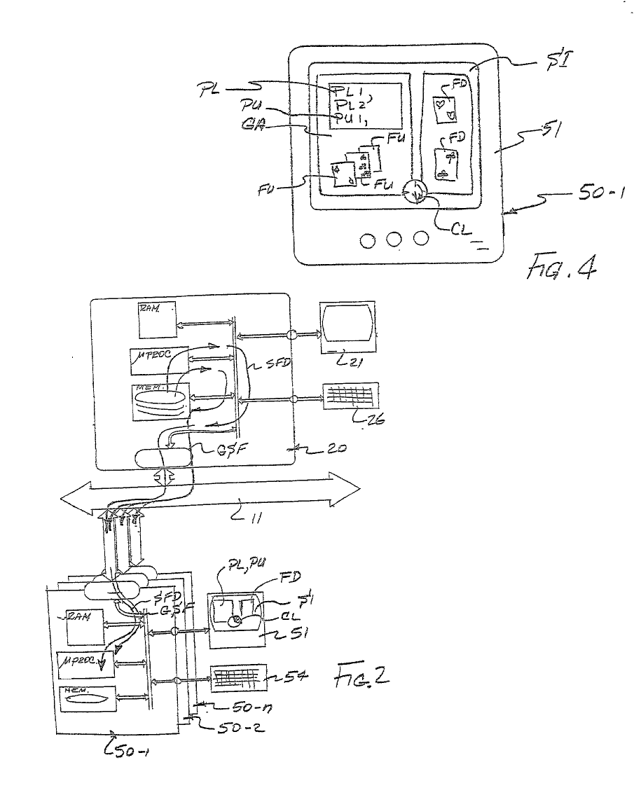

As shown in FIG. 1 a computer network, generally designated by the numeral 10, is conformed in accordance with the present invention to include a communication medium 11 to which a central processing station 20 is tied. The communication medium may be variously implemented, either as a Local Area Network LAN extending to the various rooms of a hotel or casino, Wide Area Network WAN extending between several casinos and/or hotels, a general utility communications system like the Internet or any combination thereof. In its various forms medium 11 may be tied to a plurality of remote terminals 50-1-50-n each conformed as a typical personal computer now commercially available and, of course, adapted to the communication parameters of the network.

In their customary architecture each one of the terminals 50-1-50-n includes its own video display 51, a scratch pad working memory in a form of a random access memory RAM 52, a permanent memory in the form of a disc file 53, a keyboard or other device for entering data 54 and a communication interface 55. Following further the conventional practice each one of the foregoing personal computers also includes its own microprocessor, or logical processing stage, shown generally as processor 56. A similar data processing architecture is also included in the central processing station 20 which may include its video screen 21 for monitoring purposes, an operating or scratchpad memory RAM 22, along with a disc stack 23 and a processor 24. As in the remote stations, the central processing facility 20 is also provided with its communication interface 25 and a manual input device like a keyboard 26.

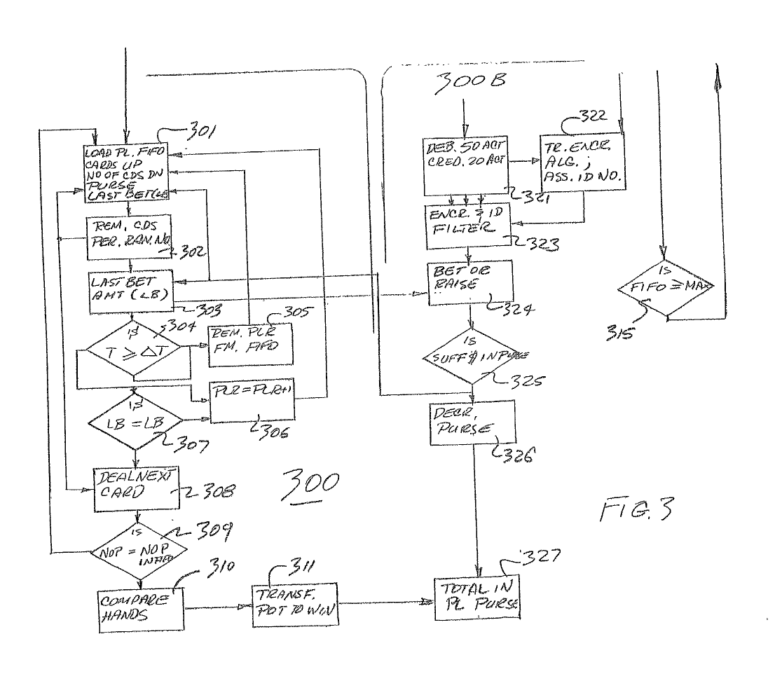

By particular reference to FIG. 3, a disc resident process generally identified by the numeral 300 may be carried out on the central processing station 20, process 300 comprising two sequences of steps proceeding in parallel, the first useful in the course of observing the inventive tournament and the second useful in the course of participation therein. Of course, that part of the process that is dedicated to passive observation, shown as process section 300A, needs few safeguards as the input thereto is simply a vector that selects the data describing the virtual card table that is to be observed. The other process section 300B, however, entails information exchanges between game participants and for that reason is both heavily encrypted and subject to various identification and password tests. This security burden convolves any processing task and for that reason the number of function that are subject thereto is kept to a minimum, with some preference for performing a majority of the tasks in section 300A.

In the generally accessible section 300A the process starts at step 301 in which the table that is currently the focus of attention is selected by both the observer and the player. In response data is loaded listing the players at the table arranged in a first-in-first-out FIFO stack, and perhaps even their identity, the remaining purse held by each of these players, the number of cards dealt to each of the players and a description of those cards that have been dealt face up. Concurrently, in step 302 the remaining undealt cards are arranged according to a random number generated sequence which, however, remains concealed. In step 303 each of the players at the table is interrogated for their next respective bet, such interrogation being conducted in sequence with a default time interval DT assigned. Should the interrogated player fail to respond within the default time interval DT, as determined in the branching step 304, the player is then considered as having folded and is removed in step 305 from the list of players that are still participating in the game. Otherwise, in step 306 the player's next bet is recorded, the database in step 301 is amended and the interrogation then advances to the next player. At the same time the bets are also compared for equality in step 307 and if so the next card is dealt per step 308 in accordance with the random arrangement of the remaining card in step 302. In step 309 the full remainder of the player FIFO stack is tested and if the cycle is completed the respective hands are compared in step 310 and thereafter the pot is transferred to the purse of the winner in step 311.

It will be noted that this process entails the only steps that entail any financial or secure information are those associated with the betting in step 303 and in the transfer of the winning pot in step 311. The remaining steps of this process are all unburdened from the requirements of security and encryption. Accordingly, the more time consuming aspects of the process residing in section 300B are essentially uncoupled from the betting sequence and the time increment DT. Thus this time increment can be devoted to the time needed to place the last bet LB and the various propagation and communication delays entailed in the network 11.

Within section 300B step 321 effects the generally well known process of debiting and crediting transactions like those associated with other monetary transfers on the network. Once this step is satisfied in step 322 the encryption algorithms and other assigned identification parameters are transferred to the contracting user station 50-1. The user is thus qualified to select the table and the game. Having made the selection the user's next betting instruction is tested in step 323 for the necessary encryption and identification details. When these are matched the bet or raise is determined in step 324 and in step 325 the bet amount is tested against the purse still held by the user and if the remainder is sufficient the last bet LB is transferred to step 303 and also to step 301 along with the decremented purse amount stored in step 326. This amount is adjusted in step 327 by any winning pot transfers in step 311 and it is this total winnings amount that is compared at the time set to determine the tournament winner.

As this process is occurring the face down card data is also transferred to the player's facility 50-1 to be displayed as and overlay FD on the screen illustrated in FIG. 4. More precisely, this signal from the central station, shown as signal SFD, is encrypted with the same algorithms as those transferred in step 322 to the user's facility 50-1. Accordingly, the general signal flow GSF from the central station 20 also includes this signal SFD which is passed by the locally resident encryption filters like those effected in step 323. Thus the screen image SI in the user's facility will include the generally available data GA comprising the players PL, their remaining purses PU, the face up cards FU, but in this instance also including the face down card data FD. All other users 50-2 through 50-n lack the specifics of the encryption to capture this data.

It should be noted that the foregoing sequence is useful both in the course of providing images to an observer, as shown in FIG. 4, and in the course of the participation in the game. Thus that portion of the data that is generally observable by any spectator may be communicated to the network in the various protocols, like the Hypertext Mark-Up Language HTML, may be displayed as a table image. Along with this data, however, is also the data that is available only to the participant, including the identity of the face-down cards dealt to this player.

In this manner a network enabled poker tournament is devised in which the qualified participant, e.g., the user serviced by the facility 50-1, can at his or her option passively observe the game at any one virtual table, or may participate in the game. In the second instance the participation is simply limited by a test step 315 in the sequence 300 that tests the initial size of the players' FIFO stack to see if it is less than a maximum. Once this condition is met the user can elect to be a participant, accumulating or decrementing his purse amount stored in step 327. Then at the previously designated time the amounts collected by each of the participants are compared and a winner is declared.

This duality is particularly useful in a network setting where large portions of any image may be transferred to the user's facility while still in the observer state. In consequence the amount of encrypted data is minimized, reducing the necessary data transfer intervals that affect the selection of the time interval DT in which the participating player needs to place his or her bet. To assist the player with this concern the screen image SI may include a clock image CL displaying the reducing time aperture which may be offset to accomodate any communication or propagation delays. This clock offset can operate as a local gate and the local time interval TD may therefore be offset relative the reconciliation interval in the central station 20.

Obviously, many modifications and variations can be effected without departing from the spirit of the invention instantly disclosed. It is therefore intended that the scope of the invention be determined solely by the claims appended hereto.

It is claimed:

1. A method for effecting a poker tournament by way of a computer enabled communication network, comprising the steps of:
displaying for general observation on said network at least one current poker game engaged in by a number of players that is less than the maximum number that can participate in said poker game;
communicating on said network qualification criteria that are to be met by such others as may want to participate as players in a succeeding poker game;
admitting the selected ones of such others as have met the qualification criteria to participate as players in said succeeding poker game displayed on said network, such participation including the placement of bets by way of said network from a purse held by each one said players;
decreasing said purse of each said player by the amount of each said bet made by said player;
comparing the card hands held by the respective ones of said players to determine the winner of said succeeding game;
increasing said purse of each said player by such amount as may have been won by said player in said succeeding game; and
comparing at a preselected time the respective purses held by each said player in order to determine a tournament winner.

2. A method according to claim 1, comprising the further step of:
distributing by way of said network, in accordance with a selection based on a random number, cards to each said player.

3. A method according to claim 2, wherein:
said criteria includes the payment of an entry fee; and
said purse includes a predetermined number of betting units for effecting said bets that are credited to each said player in exchange for said entry fee.

4. A method according to claim 3, wherein said step of admitting includes the further step of:
assigning a unique identification code to each said player.

5. A method according to claim 3, wherein said step of admitting includes the further step of:
assigning a unique encryption algorithm for each said player.

6. A method for effecting a poker tournament by way of a computer communication network, comprising the steps of:
displaying for general observation on said network at least one poker game engaged in by a number of players that is less than the maximum number that can participate in said poker game;
communicating on said network qualification criteria that are to be met by such others as may want to participate as players in a succeeding poker game;
admitting the selected ones of such others as have met the qualification criteria to participate as players in said succeeding poker game displayed on said network, such participation including the placement of bets from a purse held by each said players;
distributing by way of said network, in accordance with a selection based on a random number, cards to each said player;
comparing the card hands held by the respective ones of said players to determine the winner of said succeeding game; and
comparing at a preselected time the respective purses held by each said player in order to determine a winner.

7. A method according to claim 6, comprising the further steps of:
decreasing said purse of each said player by the amount of each said bet made by said player; and
increasing said purse of each said player by the amount won in said succeeding game.

8. A method according to claim 7, wherein:
said criteria includes the payment of an entry fee; and
said purse includes a predetermined number of betting units for effecting said bets that are credited to each said player in exchange for said entry fee.

9. A method according to claim 8, wherein said step of admitting includes the further step of:
assigning a unique identification code to each said player.

10. A method according to claim 8, wherein said step of admitting includes the further step of:
assigning a unique encryption algorithm for each said player.

11. A method for effecting a poker tournament by way of a computer network, comprising the steps of:
displaying for general observation on said network at least one current poker game engaged in by a number of players that is less than the maximum number that can participate in said poker game;
communicating on said network qualification criteria that are to be met by such others as may want to participate as players in a succeeding poker game;
admitting the selected ones of such others as have met the qualification criteria to participate as players in said succeeding poker game displayed on said network, such participation including the placement of bets by way of said network from a purse held by each one said players;
decreasing said purse of each said player by the amount of each said bet made by said player;
distributing by way of said network, in accordance with a selection based on a random number, cards to each said player;
comparing the card hands held by the respective ones of said players to determine the winner of said succeeding game;
increasing said purse of each said player by such amount as may have been won by said player in said succeeding game; and
comparing at a preselected time published on said network the respective purses held by each said player in order to determine a tournament winner.

12. A method for effecting a poker tournament on a computer network according to claim 11, comprising the further step of:
providing a predetermined time interval to each said player for communicating on said network said bet.

13. A method for effecting a poker tournament on a computer network according to claim 12, wherein:
said criteria includes the payment of an entry fee; and
said purse includes a predetermined number of betting units for effecting said bets that are credited to each said player in exchange for said entry fee.

14. A method for effecting a poker tournament on a computer network according to claim 13, wherein said step of admitting includes the further step of:
assigning a unique identification code to each said player.

15. A method for effecting a poker tournament on a computer network according to claim 13, wherein said step of admitting includes the further step of:
assigning a unique encryption algorithm for each said player.
